(19) United States
(12) Patent Application Publication
(10) Pub. No.: US 2024/0080804 A1
(43) Pub. Date: Mar. 7, 2024

(54) BUSY Indication Transmitted by a Multi-SIM User Equipment

(71) Applicant: Apple Inc., Cupertino, CA (US)

(72) Inventors: Sethuraman GURUMOORTHY, San Ramon, CA (US); Yuqin CHEN, Beijing (CN); Adesh KUMAR, San Diego, CA (US); Fangli XU, Beijing (CN); Haijing HU, Los Gatos, CA (US); Naveen Kumar R. PALLE VENKATA, San Diego, CA (US); Sarma V VANGALA, Campbell, CA (US); Srirang A LOVLEKAR, Fremont, CA (US); Zhibin WU, Los Altos, CA (US)

(21) Appl. No.: 18/261,559

(22) PCT Filed: Jan. 14, 2021
(86) PCT No.: PCT/CN2021/071845

§ 371 Date: Jul. 14, 2023

(51) Int. Cl. H04W 68/12; H04W 76/34

(52) U.S. Cl. CPC H04W 68/12; H04W 76/34; H04W 88/06

(57) ABSTRACT

A multi-universal subscriber identity module (MUSIM) user equipment (UE) is configured to operate in an Radio Resource Control (RRC) inactive state with a first network associated with the first SIM, operate in an RRC connected state with a second network associated with the second SIM, receive a page from the first network, determine that a priority of at least one operation being performed between the UE and the second network is higher than a priority of the page and send a BUSY indication to the first network in response to the page.

### TECHNICAL FIELD

This application relates generally to wireless communication, and in particular relates to BUSY Indication Transmitted by a Multi-SIM User Equipment.

### BACKGROUND

A user equipment (UE) may be configured with multiple universal subscriber identity modules (SIMs) (e.g., two SIMs). The two SIMs allow the UE maintain a connection with two separate networks, e.g., a first network and a second network, or two connections with the same network. The UE may be in a first connection state with the first network (e.g., a Radio Resource Control (RRC) Connected state) and a second connection state with the second network (e.g., an RRC Idle or RRC Inactive state). The UE may be actively exchanging data with the first network and simultaneously monitoring the second network to determine if a page is received from the second network. If a page is received from the second network, the UE needs to determine how to handle the page.

### SUMMARY

Some exemplary embodiments are related to a user equipment (UE) having a multi universal subscriber identity module (MUSIM) array having a first SIM and a second SIM, a transceiver configured to communicate with one or more networks and a processor communicatively coupled to the transceiver and the MUSIM and configured to perform operations. The operations include operating in an Radio Resource Control (RRC) inactive state with a first network associated with the first SIM, operating in an RRC connected state with a second network associated with the second SIM, receiving a page from the first network, determining that a priority of at least one operation being performed between the UE and the second network is higher than a priority of the page and sending a BUSY indication to the first network in response to the page.

Other exemplary embodiments are related to a processor communicatively coupled to a multi universal subscriber identity module (MUSIM) array having a first SIM and a second SIM of a user equipment (UE), the processor being configured to perform operations. The operations include operating in an Radio Resource Control (RRC) inactive state with a first network associated with the first SIM, operating in an RRC connected state with a second network associated with the second SIM, receiving a page from the first network, determining that a priority of at least one operation being performed between the UE and the second network is higher than a priority of the page and sending a BUSY indication to the first network in response to the page.

Still further exemplary embodiments are related to a processor of a base station configured to perform operations. The operations include operating in an Radio Resource Control (RRC) inactive state with a user equipment (UE), sending a page to the UE, receiving, in response to the page, a BUSY indication and sending, in response to the BUSY indication, an RRC release message.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary signaling diagram where the UE sends a BUSY indication using a RRC Resume Request message according to various exemplary embodiments.

FIG. 5 shows an exemplary signaling diagram where the UE sends a BUSY indication using a combination of RRC Resume Request and RRC Setup Complete messages according to various exemplary embodiments.

FIG. 6 shows an exemplary signaling diagram 600 where the UE 110 sends a BUSY indication using an Signaling Radio Bearer (SRB) message according to various exemplary embodiments.

### DETAILED DESCRIPTION

The exemplary embodiments may be further understood with reference to the following description and the related appended drawings, wherein like elements are provided with the same reference numerals. The exemplary embodiments describe various manners of a user equipment (UE) sending a non-access stratum (NAS) BUSY indication to a network when the UE is in an RRC inactive state with the network.

The exemplary embodiments are described with regard to one or more networks that include SC NR radio access technology (RAT). However, the exemplary embodiments may be implemented in other types of networks using the principles described herein. For example, the exemplary embodiments may also be implemented in Long Term Evolution (LTE) networks, Third Generation (3G) networks and any other type of legacy networks.

Throughout this description reference is made to the SIMs of the performing a function (e.g., communicating with the one or more wireless networks). However, those skilled in the art will understand that the SIMs themselves do not perform any functions or operations. Rather, the UE, or more precisely a processor of the UE, implements one or more protocol stacks using the credentials and other information stored on the SIMs and then establishes a connection with the one or more networks using the one or more protocol stacks. Thus, when referring to a SIM communicating with a network, this should be understood to include the UE or the processor of the UE communicating via a connection associated with the SIM. Similarly, any other operation attributed to the SIM herein should be understood to be an operation being performed by a protocol stack implemented by the processor using the information provided by the SIM.

The exemplary embodiments are also described with regard to a UE. However, the use of a UE is merely for illustrative purposes. The exemplary embodiments may be utilized with any electronic component that may establish a connection with a network and is configured with the hardware, software, and/or firmware to exchange information and data with the network. Therefore, the UE as described herein is used to represent any electronic component.

When operating on a network cell, a UE may be configured to be in one of a plurality of different radio resource control (RRC) operating states (e.g., RRC connected state, RRC idle state, RRC inactive state, etc.). Those skilled in the art will understand that when the UE is in an RRC connected state, the UE and the network may be configured to exchange information and/or data. The exchange of information and/or data may allow the UE to perform functionalities available via the network connection. Further, those skilled in the art will understand that when the UE is in the RRC idle state, the UE is generally not exchanging data with the network and radio resources are not being assigned to the UE within the network. However, when the UE is in RRC idle state, the UE may monitor for information and/or data transmitted by the network (e.g., paging, a wake-up signal (WUS), etc.).

Another operating state may be characterized as RRC inactive state. In RRC inactive state, the UE suspends the RRC connection while minimizing signaling and power consumption. Similar to RRC idle state, when the UE is in the RRC inactive state, the UE is generally not exchanging data with the network. When the UE is in RRC inactive state, the UE may still monitor for information and/or data transmitted by the network (e.g., paging, WUS, etc.).

According to some exemplary embodiments, the UE may send a NAS BUSY indication to a network using a RRC Resume Request message. According to other exemplary embodiments, the UE may send a NAS BUSY indication to a network using a combination of RRC Resume Complete and RRC Setup Complete messages. According to still further exemplary embodiments, the UE may send a NAS BUSY indication to a network using a newly defined Signaling Radio Bearer (SRB) message. According to additional exemplary embodiments, the UE may send a NAS BUSY indication to a network using a dedicated preamble.

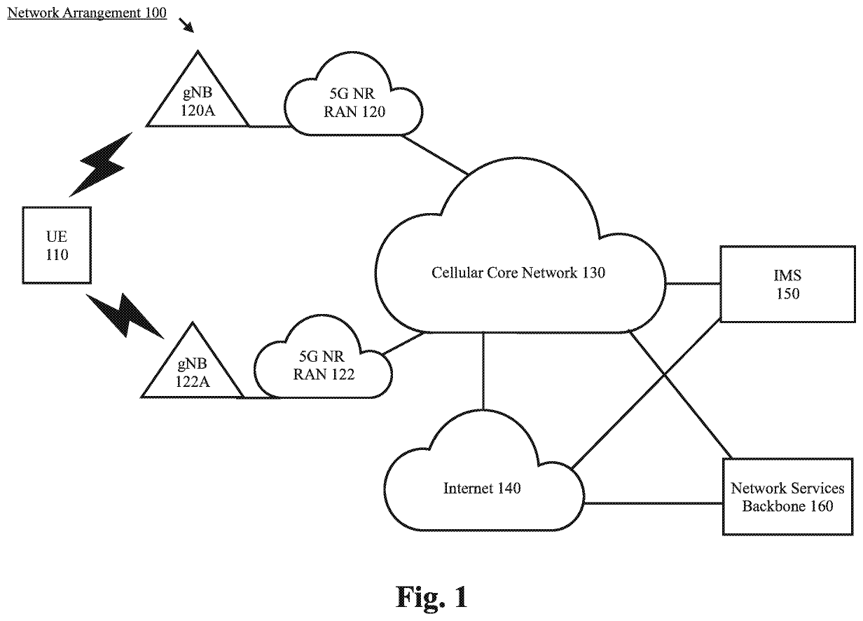

FIG. 1 shows an exemplary network arrangement 100 according to various exemplary embodiments. The exemplary network arrangement 100 includes a UE 110. It should be noted that any number of UEs may be used in the network arrangement 100. Those skilled in the art will understand that the UE 110 may alternatively be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the networks with which the UE 110 may wirelessly communicate are a first 5G New Radio (NR) radio access network (5G NR-RAN) 120 and a second 5G NR RAN 122. However, it should be understood that the UE 110 may also communicate with other types of wireless networks (e.g., Long Term Evolution (LTE) networks, legacy cellular networks, wireless local access network (WLAN) networks, etc., and the UE 110 may also communicate with networks over a wired connection. Therefore, the UE 110 may include chipsets to communicate with the various networks, e.g., a 5G NR chipset, an LTE chipset an ISM chipset, etc.

The 5G NR-RAN 120 and 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UE that are equipped with the appropriate cellular chip set.

The UE 110 may connect to the 5G NR-RAN 120 via the next generation Node B (gNB) 120A and to the 5G NR-RAN 122 via the gNB 120B. During operation, the UE 110 may be within range of gNBs for both 5G NR-RAN 120 and 122 and may simultaneously connect to the 5G NR-RAN 120 via the gNB 120A and to the 5G NR-RAN 122 via the gNB 120B.

Those skilled in the art will understand that any association procedure may be performed for the UE 110 to connect to the 5G NR-RAN 120. For example, as discussed above, the 5G NR-RAN 120 and 122 may be associated with particular cellular provider)s) where the UE 110 and/or the user thereof has a contract and credential information (e.g., stored on a SIM card). Upon detecting the presence of the 5G NR-RAN 120 and/or 5G NR-RAN 122, the UE 110 may transmit the corresponding credential information to associate with the 5G NR-RAN 120 and/or 5G NR-RAN 122. More specifically, the UE 110 may associate with a specific base station (e.g., the gNB 120A of the 5G NR-RAN 120 and/or the gNB 122A of the 5G NR-RAN 122).

In addition to the networks 120 and 122, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network, e.g. the 5GC for NR. The cellular core network 130 also manages the traffic that flows between the cellular network and the Internet 140. It should be noted that in the network arrangement 100, one cellular core network 130 is shown. However, if the 5G NR-RAN 120 and the 5G NR-RAN 122 are deployed by different carriers, there may be different cellular core networks associated with each of the carriers. The different core networks may communicate either directly or indirectly with each other. Thus, a single cellular core network is only exemplary.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

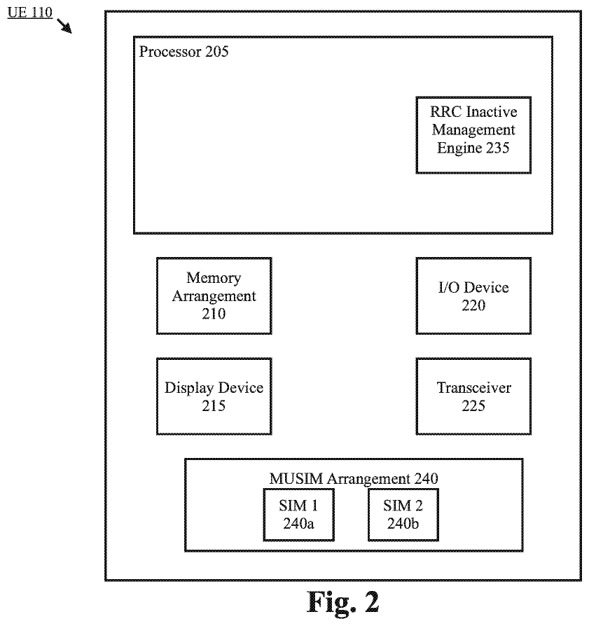

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, other components 230, and a multi-universal SIM (MUSIM) arrangement 240. The other components 230 may include, for example, an audio input device, an audio output device, a battery that provides a limited power supply, a data acquisition device, ports to electrically connect the UE 110 to other electronic devices, one or more antenna panels, etc. For example, the UE 110 may be coupled to an industrial device via one or more ports. The MUSIM arrangement 240 may include a first SIM (SIM 1) 240a and a second SIM (SIM 2) 240b, each of which may be used to connect to different gNBs 120A, 120B of different networks.

The processor 205 may be configured to execute a plurality of engines of the UE 110. For example, the engines may include an RRC Inactive management engine 235. The RRC Inactive management engine 235 may perform various operations related to responding to pages from a network when the UE 110 is in the RRC inactive state with respect to the network. Examples of the UE 110 responding to pages will be described in greater detail below.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UE, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the LTE-RAN 122, the WLAN 124, etc. Accordingly, the transceiver 225 may operate on a variety of different frequencies or channels (e.g., set of consecutive frequencies).

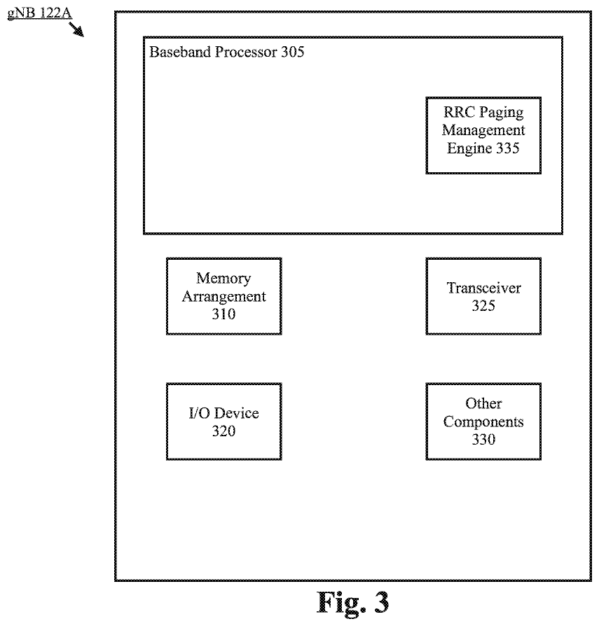

FIG. 3 shows an exemplary network cell, in this case gNB 122A, according to various exemplary embodiments. The gNB 122A may represent any access node of the 5G NR network through which the UEs 110 may establish a connection. The gNB 122A illustrated in FIG. 3 may also represent the gNB 120A.

The gNB 122A may include a processor 305, a memory arrangement 310, an input/output (I/O) device 320, a transceiver 325, and other components 330. The other components 330 may include, for example, a power supply, a data acquisition device, ports to electrically connect the gNB 120A to other electronic devices, etc.

The processor 305 may be configured to execute a plurality of engines of the gNB 122A. For example, the engines may include a paging management engine 335 for performing operations including configuring the UE 110 in the inactive state, sending pages to the UE 110 and handling paging responses from the UE 110. Examples of these operations will be described in greater detail below.

The above noted engine being an application (e.g., a program) executed by the processor 305 is only exemplary. The functionality associated with the engines may also be represented as a separate incorporated component of the gNB 122A or may be a modular component coupled to the gNB 122A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary aspects may be implemented in any of these or other configurations of a gNB.

The memory 310 may be a hardware component configured to store data related to operations performed by the UEs 110. The I/O device 320 may be a hardware component or ports that enable a user to interact with the gNB 122A. The transceiver 325 may be a hardware component configured to exchange data with the UE 110 and any other UE in the system 100. The transceiver 325 may operate on a variety of different frequencies or channels (e.g., set of consecutive frequencies). Therefore, the transceiver 325 may include one or more components (e.g., radios) to enable the data exchange with the various networks and UEs.

As described above, the UE 110 may have a connection to the 5G NR-RAN 120 via the gNB 120A and using the credentials associated with SIM 1 240A. Simultaneously, the UE 110 may also have a connection to the 5G NR-RAN 122 via the gNB 122A and using the credentials associated with SIM 2 240B. Consider the following scenario, the connection with the 5G NR-RAN 120A is in the RRC connected state and the connection with the 5G NR-RAN 122 is in the RRC inactive or RRC idle state. Thus, in this scenario, it may be considered that the UE 110 is actively performing data exchanges with the 5G NR-RAN 120. It may also be considered that the UE 110 is monitoring, based on the discontinuous reception (DRX) cycle of the 5G NR-RAN 122, for paging on the 5G NR-RAN 122. This monitoring may be performed during pre-agreed occasions between the UE 110 and the 5G NR-RAN 120. During this monitoring, the UE 110 may receive a mobile terminating (MT) page from the 5G NR-RAN 122. It may further be considered that the MT page is for an operation that has a lower priority than the operations currently being performed between the UE 110 and the 5G NR-RAN 120. The UE 110 needs to handle the MT page from the 5G NR-RAN 122. Some exemplary embodiments are related to the UE 110 sending a non-access stratum (NAS) message including a BUSY indication) to the 5G NR-RAN 122 for both the 5G System (5GS) and Evolved Packet System (EPS). However, there may be security and other considerations when sending a BUSY indication when the UE 110 is in the RRC inactive state with the 5G NR-RAN 122. The exemplary embodiments may also address the security and other considerations of sending a BUSY indication when the UE 110 is in the RRC inactive state.

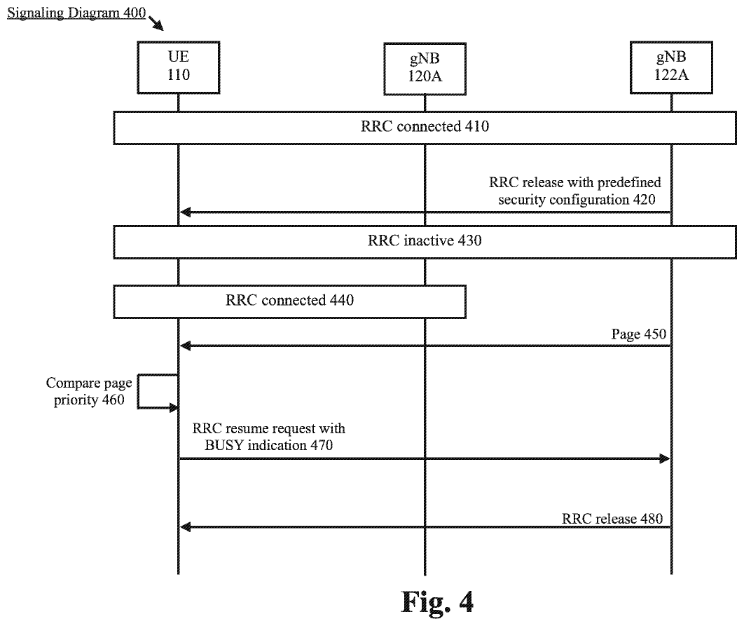

Prior to describing the signaling between the UE and the network to allow the UE to send the BUSY indication, the UE and the network may communicate to indicate that the UE and the network support the functionality associated with the BUSY indication. The UE may indicate to the network (e.g., the gNB) that the UE has the capability to send a BUSY indication as a response to paging. For example, the capability may be reported as part of the information element (IE) UECapabilityInformation (access stratum (AS) level) or during an initial ATTACH REQUEST/REGISTRATION REQUEST (NAS level). The gNB may also indicate to the UE that the gNB includes the capability to handle a BUSY indication in response to a page. For example, the network capability may be reported as part of the ATTACH ACCEPT/REGISTRATION ACCEPT or broadcast as part of an existing System Information Block (SIB) or a new MUSIM specific SIB. Thus, prior to the signaling as described in FIGS. 4-6, the UE and the network may understand that each supports the BUSY indication in the inactive and/or the idle state.

FIG. 4 shows an exemplary signaling diagram 400 where the UE 110 sends a BUSY indication using a RRC Resume Request message according to various exemplary embodiments. The exemplary signaling diagram 400 will be described with reference to the network arrangement 100 of FIG. 1, the UE 110 of FIG. 2 and the base station of FIG. 3. In the description of signaling diagram 400, it will be described that the UE 110 is communicating with the gNB 120A and/or the gNB 122A. It should be understood that for the signaling diagrams of FIGS. 4-6, the communications/operations with the gNBs are also communications with each respective network (e.g., 5G NR-RAN 120 or 5G NR-RAN 122). For example, when it is described that the UE 110 is in an RRC connected state with the gNB 122A, this should be understood as the UE 110 being in the RRC connected state with the 5G NR-RAN 122.

In 410, it may be considered that the UE 110 is currently in an RRC connected state with the gNB 122A. The UE 110 may then transition to the RRC inactive state. This may include the gNB 122A sending, in 420, an RRC Release message. Those skilled in the art will understand that when the 5G NR-RAN 122 wants to place the UE 110 into the RRC inactive state, the RRC Release message 420 will include a suspend configuration for the UE 110. The suspend configuration includes parameters for the RRC inactive state for the UE 110 such that the UE 110 may quickly reestablish the RRC connected state, if required. In the RRC inactive state, the UE 110 and the 5G NR-RAN 122 save at least a portion of the context of the connection that allows for the quick reestablishment of the connection. In the exemplary embodiments, the suspend configuration may also include a predefined security configuration. The predefined security configuration may allow the UE 110 and the gNB 122A to exchange verified signaling messages when the UE 110 is in the RRC inactive state. The UE 110 may store the predefined security configuration and, as will be described in greater detail below, the predefined security configuration may be used if the UE 110 has to send any BUSY indication while in the RRC inactive state.

In 430, the UE 110 has transitioned to the RRC inactive state with the gNB 122A and, in 440, the UE 110 has transitioned to the RRC connected state with the gNB 120A. As described above, when the UE 110 is in the operating state as shown in signaling diagram 400, e.g., RRC inactive state with 5G NR-RAN 122 and RRC connected state with 5G NR-RAN 120, the UE 110 will continue to monitor the 5G NR-RAN 122 for pages.

In 450, it may be considered that the gNB 122A sends a page to the UE 110. In 460, the UE 110 compares the priority of the page 450 to the priority of the current operations being performed with respect to the gNB 120A (5G NR-RAN 120). When the UE 110 determines that the priority of the operations with the 5G NR-RAN 120 are higher than the priority of the page 450, the UE 110 determines that a NAS BUSY indication should be sent to the gNB 122A. In some exemplary embodiments, the page 450 includes an indication as to whether the page is related to a voice or non-voice operation. The UE 110 may use this information to determine whether the page or the current operations on the RRC connected network have priority. The determination of priority is not limited to a voice/non-voice indication in the page as the page may include other indicia of priority.

In 470, the UE 110 sends an RRC Resume Request message to the gNB 122A. The RRC Resume Request message includes the NAS BUSY indication that uses the predefined security configuration that was previously sent during the RRC release 420. Those skilled in the art will understand RRC Resume Request messages do not normally include a security configuration. The gNB 122A receives the RRC Resume Request message with the predefined security configuration and understands that the RRC Resume Request message is of a type that includes a BUSY indication. The gNB 122A decodes the message with the BUSY indication, which provides the gNB 122A with an indication that the UE 110 is going to ignore the page 450.

As described above, the gNB 122A, when receiving the RRC Resume Request message that uses the predefined security configuration, will understand that the RRC Resume Request message is not a normal resume request to resume the RRC connected state, but is rather a message used to convey the BUSY indication. Thus, the gNB 122A does not respond with an RRC. Resume message, but sends an RRC release message 480 because the gNB 122A understands that the UE 110 does not want to transition to the RRC connected state at this time. The RRC release message 480 may be similar to the RRC release message 420 described above, e.g., including the predefined security configuration, that may be used to handle future pages. In other exemplary embodiments, the RRC release message 480 may have an indication to reuse the previously configured predefined security configuration while remaining in the RRC inactive state. In further exemplary embodiments, the RRC release message 480 may be a normal release message that is used to transition the UE 110 to the RRC idle state.

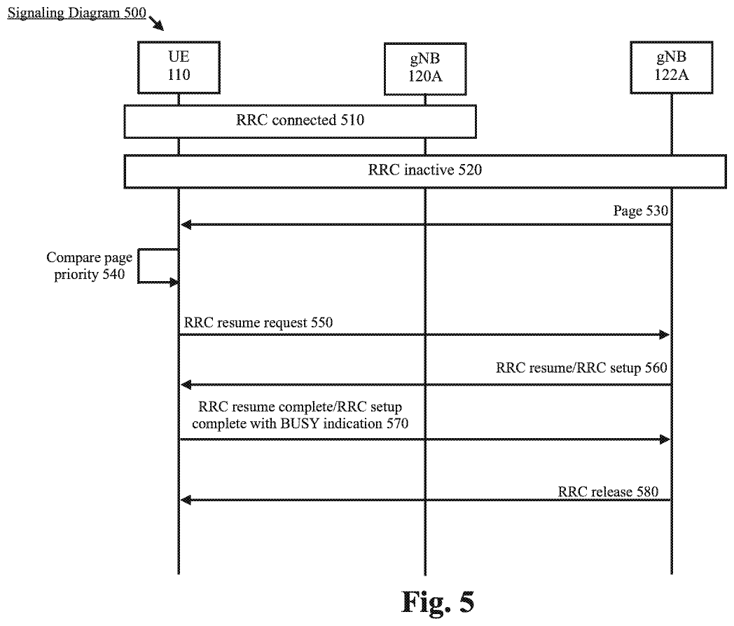

FIG. 5 shows an exemplary signaling diagram 500 where the UE 110 sends a BUSY indication using a combination of RRC Resume Request and RRC Setup Complete messages according to various exemplary embodiments. The exemplary signaling diagram 400 will be described with reference to the network arrangement 100 of FIG. 1, the UE 110 of FIG. 2 and the base station of FIG. 3. In the description of signaling diagram 400, it will be described that the UE 110 is communicating with the gNB 120A and/or the gNB 122A.

In 510, it may be considered that the UE 110 is in the RRC connected state with the gNB 120A. In 520, it may be considered that the UE 110 is in the RRC inactive state with the gNB 122A. As described above, when the UE 110 is in the operating state as shown in signaling diagram 500, e.g., RRC inactive state with 5G NR-RAN 122 and RRC connected state with 5G NR-RAN 120, the UE 110 will continue to monitor the 5G NR-RAN 122 for pages.

In 530, it may be considered that the gNB 122A sends a page to the UE 110. In 540, the UE 110 compares the priority of the page 530 to the priority of the current operations being performed with respect to the gNB 120A (5G NR-RAN 120). When the UE 110 determines that the priority of the operations with the 5G NR-RAN 120 are higher than the priority of the page 530, the UE 110 determines that a NAS BUSY indication should be sent to the gNB 122A.

In 550, the UE 110 sends an RRC Resume Request message to the gNB 122A. The RRC Resume Request message 550 is a normal message, unlike the RRC Resume Request message 470 described above. In 560, in response to the RRC Resume Request message 550, the gNB 122A sends an RRC Resume/RRC Setup message. It should be understood that the gNB 122A response to the RRC Resume Request message 550, may be either a RRC Resume message (e.g., if the 5G NR-RAN 122 has a valid stored context) or an RRC Setup message (e.g., if the 5G NR-RAN 122 does not have a valid stored context). Thus, in 560, either message may be sent. Similarly, in 570, in response to the RRC Resume or RRC Setup message 560, the UE 110 sends an RRC Resume Complete or RRC Setup Complete message. The RRC Resume Complete/RRC Setup Complete message 570 includes the NAS BUSY indication.

When the gNB 122A receives the RRC Resume Complete/RRC Setup Complete message with the NAS BUSY indication, the gNB 122A understands that the BUSY indication was in response to the page 530 and the RRC Resume Request message 550 was sent for the purpose of sending the BUSY indication. The gNB 122A will understand that the UE 110 will ignore the page 530. Thus, in 580, the gNB 122A sends an RRC Release message because the gNB 122A understands that the UE 110 does not want to transition to the RRC connected state at this time. Again, the RRC release message 580 may include information for the UE 110 to remain the RRC inactive state or to transition the UE 110 to the RRC idle state.

Comparing the signaling of FIGS. 4 and 5, it can be seen that in FIG. 4, the RRC release message 420 with the predefined security configuration is used because the RRC resume request message 470 that is sent while the UE 110 is in the inactive state would not normally have a security configuration. Thus, the gNB 122A preconfigures the security configuration of the UE 110 to allow the UE 110 to send an RRC resume request message 470 in the inactive state that includes the BUSY indication. In contrast, in FIG. 5, because the UE 110 is responding to the RRC Resume or RRC Setup message 560 where a security context has been set up for the transition to the RRC connected state, the UE 110 does not require the predefined security configuration to send the RRC Resume Complete/RRC Setup Complete.

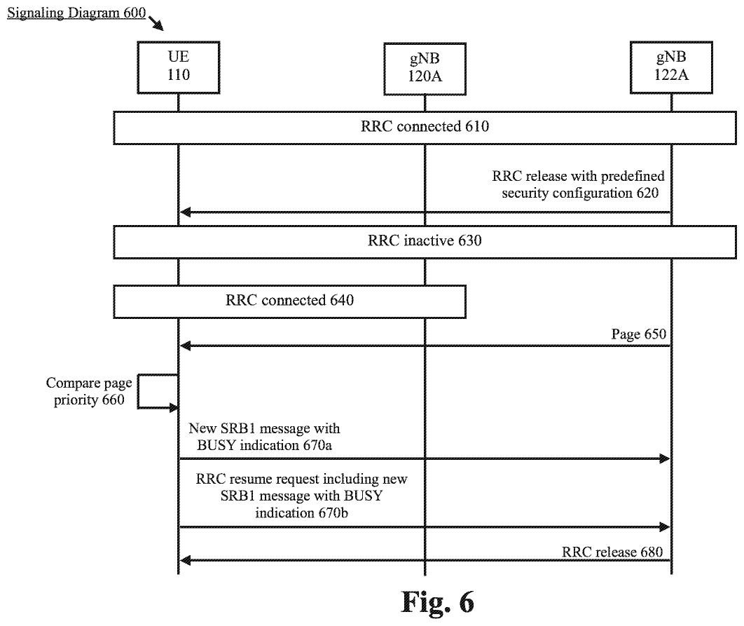

FIG. 6 shows an exemplary signaling diagram 600 where the UE 110 sends a BUSY indication using an Signaling Radio Bearer (SRB) message according to various exemplary embodiments. Those skilled in the art will understand that SRBs are radio bearers used for the transmission of RRC and NAS messages. The exemplary embodiments are described with respect to a new SRB1 message. Those skilled in the art will understand that SRB1 is generally used for RRC and NAS messages using the Dedicated Control Channel (DCCH) logical channel prior to the establishment of SRB2. The new SRB1 message may be considered to be an SRB1 message that includes a NAS BUSY indication. The exemplary signaling diagram 600 will be described with reference to the network arrangement 100 of FIG. 1, the UE 110 of FIG. 2 and the base station of FIG. 3.

In 610, it may be considered that the UE 110 is currently in an RRC connected state with the gNB 122A. The UE 110 may then transition to the RRC inactive state. This may include the gNB 122A sending, in 620, an RRC Release message including a predefined security configuration as part of the suspend configuration. The predefined security configuration may be similar to the predefined security configuration described with reference to 420 of FIG. 4. Again, because the new SRB1 message will be sent prior to the establishment of SRB2 where a security context is set up between the UE 110 and the gNB 122A, the UE 110 will use the predefined security configuration to exchange the new SRB1 message with the gNB 122A.

In 630, the UE 110 has transitioned to the RRC inactive state with the gNB 122A and, in 640, the UE 110 has transitioned to the RRC connected state with the gNB 120A. In 650, it may be considered that the gNB 122A sends a page to the UE 110. In 660, the UE 110 compares the priority of the page 650 to the priority of the current operations being performed with respect to the gNB 120A (5G NR-RAN 120). When the UE 110 determines that the priority of the operations with the 5G NR-RAN 120 are higher than the priority of the page 650, the UE 110 determines that a NAS BUSY indication should be sent to the gNB 122A.

In the exemplary embodiments, the UE 110 has two options for sending the new SRB1 message. In a first option 670a, the UE 110 sends the new SRB1 message that includes the NAS BUSY indication. As described above, the new SRB1 message that includes the NAS BUSY indication will be sent using the predefined security configuration that was sent to the UE 110 in the RRC release message 620.

In a second option 670b, the UE 110 sends two separate messages, an RRC Resume Request message that includes the predefined security configuration and the new SRB1 message including the NAS BUSY indication. The gNB 122A receives the RRC Resume Request message that includes the predefined security configuration and understands that the new SRB1 message including the NAS BUSY indication will be received. The gNB 122A receives the BUSY indication (via the signaling of either 670a or 670b) and understands that the UE 110 will ignore the page 650. Thus, the gNB 122A sends an RRC release message 680 because the gNB 122A understands that the UE 110 does not want to transition to the RRC connected state at this time.

In some exemplary embodiments, a new dedicated preamble may be defined. The new preamble may be configured per UE that is to be exclusively used to send the BUSY indication. For example, when conditions to send a BUSY indication are met such as were described with respect to signaling 460, 540 or 660, the UE 110 sends a message with the new dedicated preamble to indicate to the gNB 122A that the UE 110 is going to ignore the page. To provide a specific example, the UE 110 may send an RRC resume request message to the gNB 122A. The RRC resume request message may include a bit that indicates a NAS BUSY indication. When the gNB 122A receives the RRC resume request message that includes the dedicated preamble and the bit set to indicate a NAS BUSY indication, the gNB 122A understands the UE 110 is going to ignore the page.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as LOS, Android, etc. In a further example, the exemplary embodiments of the above described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A user equipment (UE), comprising:
a multi universal subscriber identity module (MUSIM) array having a first SIM and a second SIM;
a transceiver configured to communicate with one or more networks; and
a processor communicatively coupled to the transceiver and the MUSIM and configured to perform operations comprising:
operating in a Radio Resource Control (RRC) inactive state with a first network associated with the first SIM;
operating in an RRC connected state with a second network associated with the second SIM;
receiving a page from the first network;
determining that a priority of at least one operation being performed between the UE and the second network is higher than a priority of the page; and
sending a BUSY indication to the first network in response to the page.

2. The UE of claim 1, wherein the BUSY indication is included in a RRC resume request message.

3. The UE of claim 2, wherein the operations further comprise:
receiving, from the first network via a RRC release message, a predefined security configuration, wherein the RRC resume request uses the predefined security configuration to protect the BUSY indication.

4. The UE of claim 1, wherein the operations further comprise:
sending, in response to the page, an RRC resume request message;
receiving, in response to the RRC resume request message, one of a RRC resume message or an RRC setup message; and
sending one of a RRC resume complete message or a RRC setup complete message, wherein the one of a RRC resume complete message or a RRC setup complete message includes the BUSY indication.

5. The UE of claim 1, wherein the BUSY indication is included in a signaling radio bearer (SRB) message.

6. The UE of claim 2, wherein the operations further comprise:
receiving, from the first network via a RRC release message, a predefined security configuration.

7. The UE of claim 6, wherein the operations further comprise:
sending, in response to the page, the SRB message that uses the predefined security configuration to protect the BUSY indication.

8. The UE of claim 6, wherein the operations further comprise:
sending, in response to the page, an RRC resume request message including the predefined security configuration; and
after sending the RRC resume request message, sending the SRB message including the BUSY indication.

9. The UE of claim 1, wherein the BUSY indication is included in a message that includes a dedicated preamble corresponding to the UE.

10. The UE of claim 9, wherein the message is an RRC resume request message.

11. The UE of claim 1, wherein the operations further comprise:
receiving, in response to the BUSY indication, an RRC release message from the first network.

12. The UE of claim 1, wherein the operations further comprise:
sending, to the first network, an indication that the UE supports the sending of the BUSY indication when the UE is in the inactive state with the first network, wherein the indication is one of a UECapabilityInformation information element or a message during an initial ATTACH REQUEST/REGISTRATION REQUEST.

13-21. (canceled)

22. A processor of a base station configured to perform operations comprising:
operating in a Radio Resource Control (RRC) inactive state with a user equipment (UE);
sending a page to the UE;
receiving, in response to the page, a BUSY indication; and
sending, in response to the BUSY indication, an RRC release message.

23. The processor of claim 22, wherein the operations further comprise:
sending, to the UE via a RRC release message, a predefined security configuration.

24. The processor of claim 23, wherein the BUSY indication is included in a RRC resume request message that also includes the predefined security configuration.

25. The processor of claim 23, wherein the BUSY indication is included in a signaling radio bearer (SRB) message.

26. The processor of claim 25, wherein the operations further comprise:
receiving, in response to the page, the SRB message including the BUSY indication and the predefined security configuration.

27. The processor of claim 25, wherein the operations further comprise:
receiving, in response to the page, an RRC resume request message including the predefined security configuration; and
after receiving the RRC resume request message, receiving the SRB message including the BUSY indication.

28. The processor of claim 22, wherein the operations further comprise:
receiving, in response to the page, an RRC resume request message;
sending, in response to the RRC resume request message, one of a RRC resume message or an RRC setup message; and
receiving one of a RRC resume complete message or a RRC setup complete message, wherein the one of a RRC resume complete message or a RRC setup complete message includes the BUSY indication.

29. The processor of claim 22, wherein the BUSY indication is included in a message that includes a dedicated preamble corresponding to the UE, wherein the message is an RRC resume request message.

30. (canceled)
